(19) United States
(12) Patent Application Publication
(10) Pub. No.: US 2013/0186323 A1
(43) Pub. Date: Jul. 25, 2013

(54) Biocompostable marker flag and post

(71) Applicants: William A. Oberg, Centralia, IL (US); Robert L. Comper, JR., Folsom, CA (US); Kennith R. Smudrick, Centralia, IL (US)

(72) Inventors: William A. Oberg, Centralia, IL (US); Robert L. Comper, JR., Folsom, CA (US); Kennith R. Smudrick, Centralia, IL (US)

(21) Appl. No.: 13/374,854

(22) Filed: Jan. 19, 2012

(51) Int. Cl. G09F 17/00

(52) U.S. Cl. 116/174

(57) ABSTRACT

A biocompostable marker flag and post possesses a flag that rotates freely around the post with the wind without becoming wrapped up. The post has a grooved or knurled surface for easy gripping. The post also has an annular indentation near its bottom so that the post easily breaks away without impaling a person or a limb.

### BACKGROUND OF THE INVENTION

This invention falls into the general category of landscape survey devices and into the specific category of underground utility company marker flags and posts.

Currently, utility marker flags and posts used in the industry are usually composed of a synthetic plastic flag typically measuring 4½ inches long by 4 inches wide by several microns thick, glued to a steel post that is 21 inches long with a 1/16 inch diameter. The synthetic plastic of which the flag is composed is typically made of a flexible sheet of polyethylene, polypropylene, or polystyrene.

Several problems are associated with such marker flags and posts. One targeted problem is that such flags and posts are environmental pollutants. The steel-and-plastic flags and posts are not at all biodegradable. Thus, when the marking function of the flags and posts is no longer necessary, such flags and posts need to be picked up, otherwise, they will sit wherever they are placed indefinitely. If and when they are picked up, they are either used again or they are discarded. If they are discarded, they are usually discarded as non-biodegradable trash in a land fill facility.

A second problem with currently used utility marker flags and posts is that the exposed top of the steel posts are rather sharp since they are so thin (only 1/16 inch) that they can easily impale a part of the human body, and since they are made of steel and therefore quickly rust in an outside weather environment stuck in the dirt with natural moisture, they can cause tetanus in an infected wound.

A third problem with currently used utility marker flags and posts is that since the flag is glued to the post, if the wind happens to blow in circles around the post, the flag can become entangled or wrapped up around the post and of which the visibility of such is greatly diminished.

A fourth problem with currently used utility marker flags and posts is that because of the thinness and smoothness of the steel posts it may be difficult to push the post into hard ground as these posts have no grip surfaces.

It is the object of the invention herein disclosed to solve all four of the above problem areas in the prior art.

### BRIEF SUMMARY OF THE INVENTION

The marker flag and post described herein targets and solves the above problems in the following manner. The main problem with current utility marker flags and posts as being environmental pollutants is solved by virtue of the fact that the flag and post described herein are made entirely of biocompostable materials. The flag is produced of a thin flexible bioderived sheet of material, and the post is made of a stiffer bioderived stick of material. Such biocompostable materials allow the instant flag and post to be left in the ground without having to be picked up later. The flag and post are weather resistant enough to last for the marking job being done but then over a longer term are readily absorbed into the natural environment and thus do not have to be discarded into a land fill.

The second problem mentioned above is solved by the instant post being a bit thicker than the currently used posts and also by the instant post being topped with a small solid sphere which makes the top of the post a blunt object. The problem of infection with tetanus is solved by making the instant post of a material other than iron or steel which are prone to rust in outside elements. Additionally, the instant post has an indentation part way up from its bottom which allows the post to break off easily if a person's limb or body falls on it, so as avoid impaling a person.

The third problem mentioned above is solved in the instant flag and post by attaching the flag to the post in a way that does not require the flag to be glued to the post. The flag in this case is attached to the post by having a cylindrical loop at its end through which loop the post is inserted and held in place by two molded beads on the post, such that the flag is free to rotate around the post with the wind without getting wrapped up around the post.

The fourth problem mentioned above is solved by the fact that the instant post is thicker than the currently used posts and also that this newly developed post has grooves or knurling inscribed on its surface so it is not as slippery as currently used posts and that such grooves or knurling makes the instant post easier to get a firm grip on with the hands and fingers so as to be easier to push into the ground.

### BRIEF DESCRIPTION OF THE DRAWING

The biocompostable marker flag and post of the present invention is shown in the accompanying drawing.

FIG. 1 shows slightly elevated frontal view of the biocompostable marker flag and post.

### DETAILED DESCRIPTION OF THE INVENTION

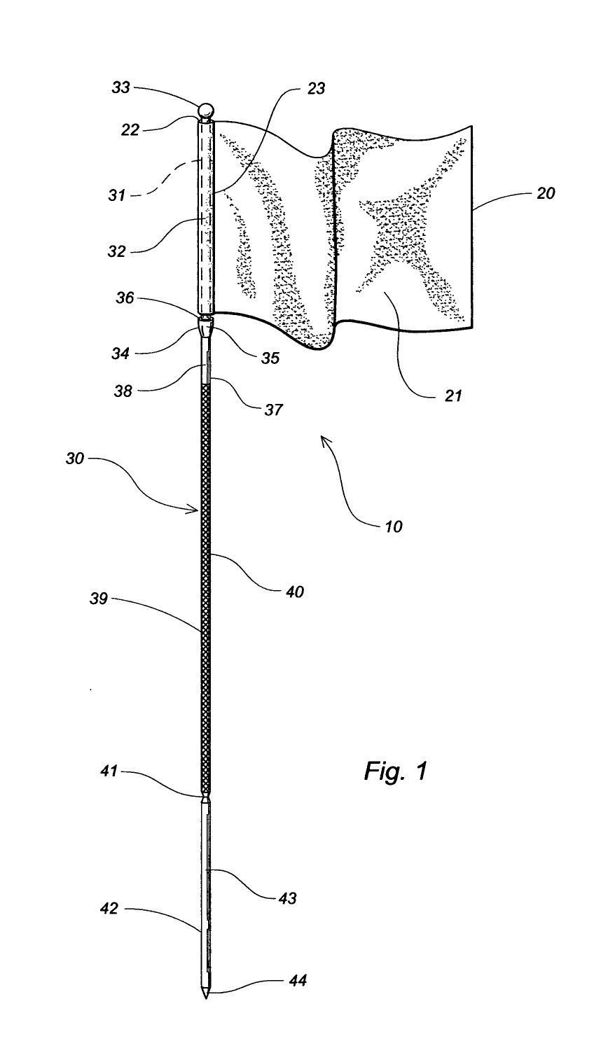

Looking at FIG. 1, it is seen that this biocompostable marker flag and post 10 is comprised of two main parts, the flag 20 and the post 30. The flag 20 is comprised of a thin flexible sheet of a biocompostable polymer and the post 30 is comprised of a stiff biocompostable polymer. The polymers for both the flag 20 and the post 30, in terms of their composition and manufacture, are described in three prior art publications which are incorporated herein by reference: MICROFIBER REINFORCED BIODEGRADABLE STARCH ESTER COMPOSITES WITH ENHANCED SHOCK ABSORBANCE AND PROCESSABILITY, U.S. Pat. No. 5,728,824, by Inventors Ramani Narayan, Mahesh Kotnis, Hideyuki Tanaka, and Nobuo Miyachi, Issued Mar. 17, 1998; METHOD OF PREPARING BIODEGRADABLE MODIFIED-STARCH MOLDABLE PRODUCTS AND FILMS, U.S. Pat. No. 5,869,647, by Inventors Ramani Narayan, Steven Bloembergen, and Amit Lathia, issued Feb. 9, 1999; and BIODEGRADABLE THERMOPLASTICIZED STARCH-POLYESTER REACTIVE BLENDS FOR THERMOFORMING APPLICATIONS, U.S. Patent Application Publication Number US 2009/0160095 A1, by Inventors Ramani Narayan, Jacqueline Stagner, and Vanessa Dias Alves, Published Jun. 25, 2009.

The flag 20 is comprised of a flexible flat sheet 21 the end of which is rolled into a cylindrical loop 22 which is sealed onto the flat sheet thermoplastically by a seam 23. A company trademark or logo may be printed on one side or the other or both sides of the flat flexible sheet 21 of the flag 20. In a preferred embodiment, the flat sheet portion 21 of the flag 20 measures 5 inches long by 4 inches wide and is 15 microns thick. In a preferred embodiment, the diameter of the cylindrical loop portion 22 of the flag 20 is ¼ inch when the loop 22 is held so as to have a circular cylindrical shape.

The biocompostable post 30 is comprised of several segments. Starting at the top of the post, which in a preferred embodiment is a total of 18 inches long, is a spherical bead 33 which in the preferred embodiment, measures ¼ inch in diameter. Below the bead 33 is a smooth segment 31, of length 4 1/16 inches and diameter ⅛ inch, around which is wrapped the cylindrical loop 22 of the flag 20.

Below the smooth segment 31 is a bullet-shaped bead 34, the top of which has a diameter of ⅜ inch and the bottom of which has a diameter of ⅛ inch. The spherical bead 33 at the top of the post 30 and the bullet-shaped bead 34 lower down on the post 30 keeps the cylindrical loop 22 of the flag 20 secured at the top of the post 30 but free to rotate around the post 30 with the wind without becoming wrapped up around the post resulting in lessoning visibility of the flag 20.

Continuing downward along the post 30 under the bullet-shaped bead 43 is a short smooth segment 37 of the post which is 1 inch long and ⅛ inch in diameter. A company trademark or logo may be printed on the smooth surface 38 of this smooth segment 37 of the post 30.

Below the smooth segment 37 of the post 30 is a long grooved or knurled segment 39 of the post which is 8 5/16 inches long and ⅛ inch in diameter. The surface 40 of this long segment 39 is grooved or knurled so as to provide a secure grip for the user in firmly sticking the post 30 into the ground for marking purposes.

Below the grooved or knurled segment 39 of the post is an annular indentation 41 which makes it easy for the post 30 to break off at that point when it is stuck in the ground if a person or a limb falls on it so as not to impale such person or limb. Such a grooved or knurled surface 40 also speeds up the biocompostability process of the post because it increases the total surface area of the post 30 which is exposed to the outside weather elements.

Below the indentation 41 in the post 30 is a bottom smooth segment 42 of the post which is 4 inches long and ⅛ inch in diameter. The bottom segment 42 has a smooth surface 43 and a semi-pointed tip 44 at its lower end to facilitate easily sticking the post into the ground. The post is stuck into the ground four inches deep so that the indentation 41 of the post is level with the surface of the ground. This way, the marker flag and post always sticks up out of the ground to the same height. Also, the top part of the flag and post 10 easily breaks away if a person or his or her limb falls on the flag so that the person or limb is not impaled.

It will be apparent to those who practice in this specialized industry that the above described biocompostable flag and post can have varying biocompostable compositions and varying physical dimensions. The dimensions given above are only one set of dimensions for an embodiment preferred by the inventors, but numerous other sets of dimensions are possible without varying from the spirit of the invention.

We claim:

1. A biocompostable flag and post.

2. A biocompostable flag and post wherein the said flag rotates around the said post without becoming wrapped up.

3. A biocompostable flag and post wherein the said flag rotates around the said post without becoming wrapped up by virtue of the said flag being held to the said post wherein the said post threads a cylindrical loop at one end of the said flag.

4. A biocompostable flag and post as described in claim 3 wherein the said flag is kept at the top of the said post by a first bead at the top of the said post and by a second bead positioned part way down the said post.

5. A biocompostable flag and post as described in claim 3 wherein the said post has a grooved or knurled surface for easier gripping when placing it in the ground.

6. A biocompostable flag and post as described in claim 4 wherein the said post has a grooved or knurled surface for easier gripping when placing it in the ground.

7. A biocompostable flag and post as described in claim 1 wherein the said post has an annular indentation near its bottom for easily breaking away if a person or limb falls on it.

8. A biocompostable flag and post as described in claim 2 wherein the said post has an annular indentation near its bottom for easily breaking away if a person or limb falls on it.

9. A biocompostable flag and post as described in claim 3 wherein the said post has an annular indentation near its bottom for easily breaking away if a person or limb falls on it.

10. A biocompostable flag and post as described in claim 4 wherein the said post has an annular indentation near its bottom for easily breaking away if a person or limb falls on it.

11. A biocompostable flag and post as described in claim 5 wherein the said post has an annular indentation near its bottom for easily breaking away if a person or limb falls on it.

12. A biocompostable flag and post as described in claim 6 wherein the said post has an annular indentation near its bottom for easily breaking away if a person or limb falls on it.
